(19) United States
(12) Patent Application Publication
(10) Pub. No.: US 2023/0222202 A1
(43) Pub. Date: Jul. 13, 2023

(54) BIOS PASSWORDS

(71) Applicant: Hewlett-Packard Development Company, L.P., Spring, TX (US)

(72) Inventors: MING CHANG HUNG, TAIPEI CITY (TW); CHIA-CHENG LIN, TAIPEI CITY (TW); WEI-CHIH HUANG, TAIPEI CITY (TW); HENG-FU CHANG, TAIPEI CITY (TW); PING HUAN YU, TAIPEI CITY (TW)

(73) Assignee: Hewlett-Packard Development Company, L.P., Spring, TX (US)

(21) Appl. No.: 18/001,432

(22) PCT Filed: Jul. 16, 2020
(86) PCT No.: PCT/US2020/042246

§ 371 Date: Dec. 9, 2022

(51) Int. Cl. G06F 21/44; G06F 21/57

(52) U.S. Cl. CPC G06F 21/44; G06F 21/572; G06F 2221/034

(57) ABSTRACT

In example implementations, a computing device is provided. The computing device includes a basic input/output system (BIOS), a memory, and a controller. The memory is to store a BIOS password, wherein the BIOS password includes a first part and a second part. The controller is to associate a first device with the first part and a second device with the second part.

### BACKGROUND

Computing devices help provide productivity. The computing devices can execute programs, process data, and the like, for a variety of different applications. A computing device may use an operating system as a host environment to execute the programs and processes.

In some instances, the firmware for the basic input/output system (BIOS) may be used to initialize the computing device. The BIOS may initialize drivers and other boot sequences to allow the operating system of the computing device to boot and allow full operation of the computing device.

### BRIEF DESCRIPTION OF THE DRAWINGS

FIG. 1 is a block diagram of an example computing device that provides a BIOS password with multiple parts to execute a BIOS of the present disclosure;

FIG. 2 is a block diagram of an example apparatus of the computing device to create a BIOS password with multiple parts of the present disclosure;

FIG. 3 is a block diagram of another example of an apparatus of the computing device to create a BIOS password with multiple parts of the present disclosure;

FIG. 4 is a flow chart of an example method for creating a BIOS password with multiple parts to execute a BIOS of the present disclosure;

FIG. 5 is an example non-transitory computer readable storage medium storing instructions executed by a processor to execute a BIOS in response to receiving a first part and a second part of a BIOS password of the present disclosure; and

FIG. 6 is an example non-transitory computer readable storage medium storing instructions executed by a processor to allow execution of a BIOS to proceed based on a first part and a second part of a BIOS password of the present disclosure.

### DETAILED DESCRIPTION

Examples described herein provide a computing device with a BIOS password that includes multiple parts. As discussed above, the BIOS may be used to initialize the computing device. Password protecting the BIOS may provide additional security to the computing device to block unauthorized access to the computing device. For example, adding a password to the BIOS may make it more difficult for unauthorized users to access to the computing device.

Some passwords may be alphanumeric passwords. However, a single alphanumeric password may not provide sufficient security. Alphanumeric passwords may be easily hacked, and unauthorized users may still be able to access the computing device.

The present disclosure provides additional security by allowing a user to store multiple parts of a BIOS password with different input devices. The BIOS password with multiple parts may control execution of the BIOS to allow access to the operating system (OS) environment. For example, a BIOS password with multiple parts may block unauthorized users from accessing the OS and applications that are executed in the OS environment. The password may include a part that is alphanumeric and a second part that may be certain movements of the input devices. As a result, the password created from the combinations of different input devices may make it more difficult to hack the BIOS and computing device.

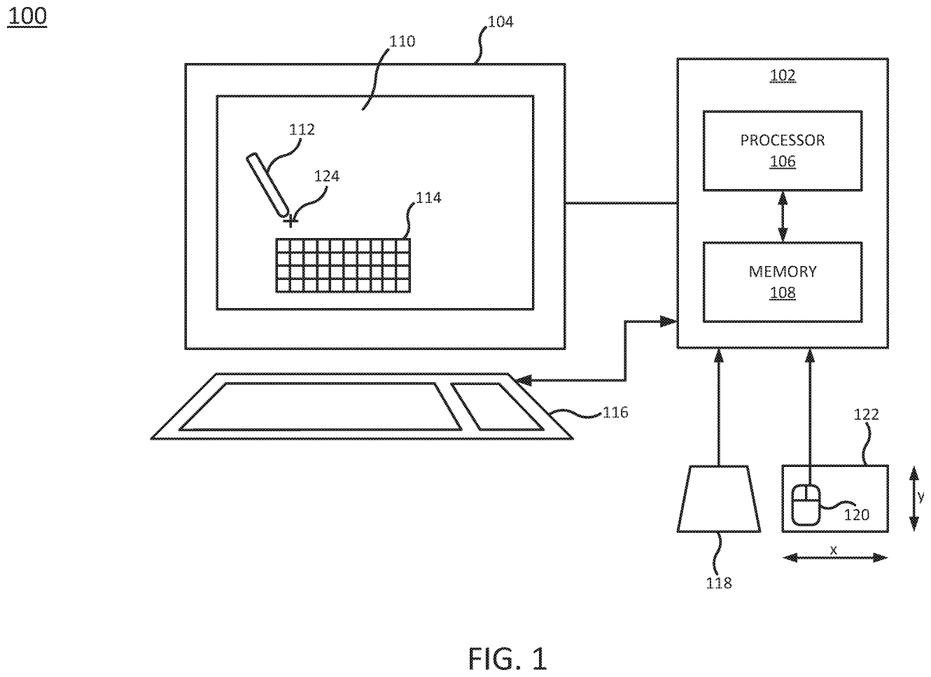

FIG. 1 illustrates an example of a computing device 100 to create a BIOS password with multiple parts of the present disclosure. In an example, the computing device 100 may include a housing 102 to enclose a processor 106 and a memory 108. The memory 108 may include various instructions and programs that are executed by the processor 106.

In an example, the housing 102 may be communicatively coupled to a display 104. Although the housing 102 and the display 104 are shown as separate components (e.g., a desktop computer), the housing 102 and the display 104 may be a single component (e.g., a laptop computer).

The display 104 may be a monitor. In an example, the display 104 may be a touch screen display. For example, the display 104 may detect interactions (e.g., touching with a finger or a stylus 112) with locations on the display 104.

In an example, the computing device 100 may include various input devices. The input devices may include the stylus 112, a virtual keyboard 114 on a touch screen display, a keyboard 116, a track pad 118, a mouse 120, and the like.

In an example, the input devices may be used to provide different parts of a multi-part Basic Input/Output System (BIOS) password. For example, the BIOS password may be composed of two or more different parts provided by inputs from two or more different input devices. To illustrate, the BIOS password may include a first part that includes an alphanumeric password provided via the keyboard 116 and a second part that includes a pattern of movement (e.g., using a single finger that moves around the perimeter) on the trackpad 118. In another example, the BIOS password may include a first part that includes a particular sequence of keys from the virtual keyboard 114 and a pattern of movement on an x-y plane 122 of the mouse 120. In yet another example, the BIOS password may include touching a location 124 on the display 110 with the stylus 112, and a numeric sequence entered via the keyboard 116.

In an example, the sequence or order in which each part of the BIOS password is entered may also be used as part of the BIOS password. Using the example of the keyboard 116 and the trackpad 118 above, the sequence may include the first part via the keyboard 116 and then the second part via the trackpad 118. If the second part of the BIOS password is provided via the trackpad 118 before the first part is provided via the keyboard 116, then the BIOS password may be deemed incorrect.

In an example, the BIOS password may be stored in the memory 108. The BIOS password may be enabled to block access to the operating system of the computing device 100. In other words, the BIOS password may block unauthorized access to the operating system (and applications executed in the operating system environment) of the computing device 100.

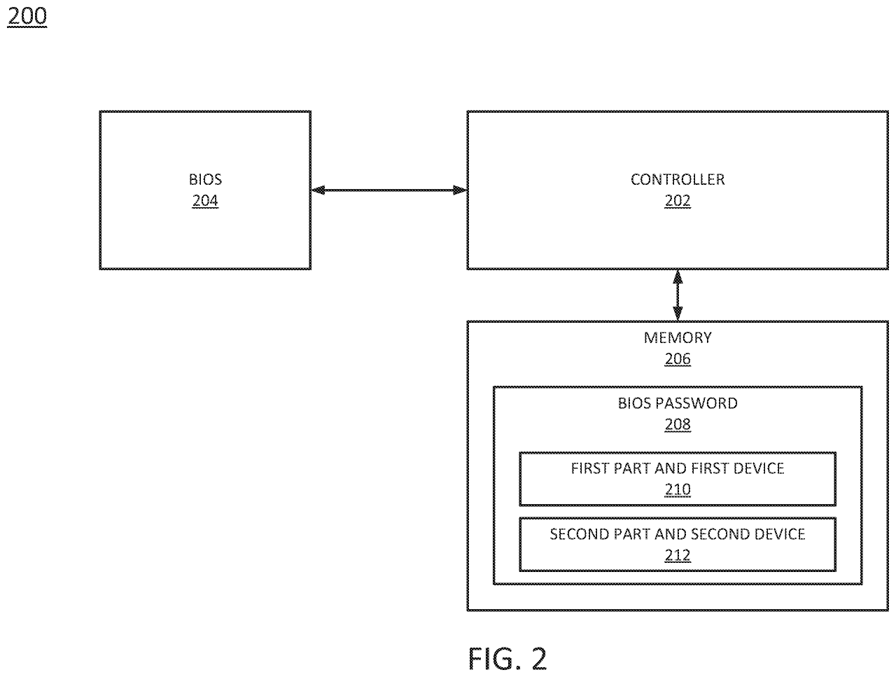

FIG. 2 illustrates an example of an apparatus to create a BIOS password with multiple parts of the present disclosure. The apparatus 200 may be part of the computing device 100 illustrated in FIG. 1.

In an example, the apparatus 200 may include a controller 202, a BIOS 204, and a memory 206. As used herein, a BIOS refers to hardware or hardware and instructions to initialize, control, or operate a computing device prior to execution of an operating system (OS) of the computing device. Instructions included within a BIOS may be software, firmware, microcode, or other programming that define or control functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the memory 206 may be a non-transitory computer readable medium. For example, the memory 206 may be a hard disk drive, a solid state drive, a random access memory (RAM), a read only memory (ROM), and the like. The memory 206 may store a BIOS password 208 that can be compared against a received BIOS password to authorize execution of the BIOS 204.

In an example, the BIOS password 208 may include a first part and first device 210 and a second part and a second device 212. As illustrated in the examples described above, the BIOS password 208 may include multiple parts. Each part may be provided by different input devices. The different parts of the BIOS password 208 may include alphanumeric text or movement of the input devices.

In an example, the controller 202 may be communicatively coupled to the BIOS 204 and the memory 206. The controller 202 may control execution of the BIOS 204. The controller 202 may control execution of the BIOS 204 based on a received BIOS password that matches the BIOS password 208 stored in the memory 206.

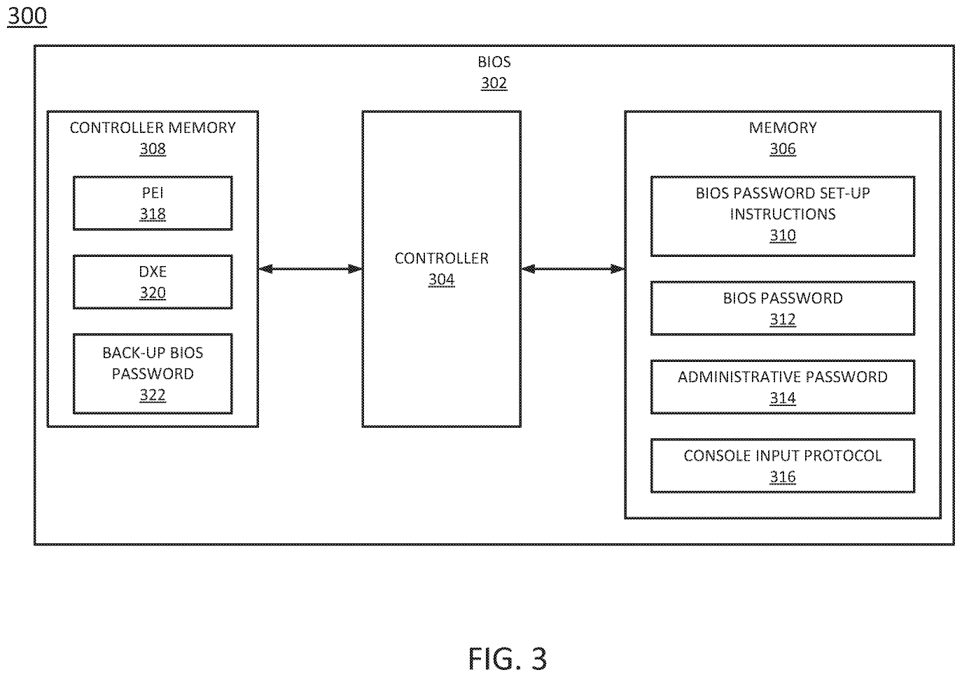

FIG. 3 illustrates a block diagram of another example of an apparatus 300 of the computing device 100 to create a BIOS password with multiple parts of the present disclosure. In an example, the apparatus 300 may include a BIOS 302. The BIOS 302 may include a controller 304, a memory 306, and a controller memory 308. The controller 304 may be communicatively coupled to the memory 306 and the controller memory 308. The controller 304 may execute instructions stored in the memory 306 and the controller memory 308.

The memory 306 may be a non-transitory computer readable medium. For example, the memory 306 may be a hard disk drive, a solid state drive, a random access memory (RAM), a read only memory (ROM), and the like. The memory 306 may store BIOS password set-up instructions 310, a BIOS password 312, an administrative password 314, and a console input protocol 316.

In an example, the BIOS password set-up instructions 310 may include a series of menus that may be displayed in a BIOS menu. The BIOS password set-up instructions may prompt a user to provide each part of the BIOS password with a different device. For example, the BIOS password set-up instructions 310 may warn a user if the user attempts to enter multiple parts of the BIOS password 312 with the same device. The BIOS password set-up instructions may guide a user to store the different parts associated with different devices for the BIOS password. The BIOS password 312 may then be stored in the memory 306.

In an example, the administrative password 314 may be known to an administrator, but not to the user of the computing device 100. The administrative password 314 may allow an administrator to reset the BIOS password 312 if the user forgets the BIOS password 312.

In an example, the console input protocol 316 may include instructions that allow the BIOS 302 to track movement of input devices. For example, the BIOS 302 may be executed before drivers for input devices are loaded and executed. Thus, the console input protocol 316 may allow movement of the input devices that can be used as a part of the BIOS password 312 to be tracked in the BIOS menu. For example, the movement of the input devices may include movement along an x-y plane (e.g., the x-y plane 122 illustrated in FIG. 1). The console input protocol 316 may also track movement on other input devices such as a touch-screen display, the track pad 118, and the like.

In an example, the controller memory 308 may be a secure memory that is accessible by the controller 304. The controller memory 308 may not be accessible by any other components or devices within the computing device 100. The controller memory 308 may include a pre-extensible firmware interface (PEI) 318, a driver execution environment (DXE) 320, and a back-up BIOS password 322.

In an example, the PEI 318 and the DXE 320 may be part of the BIOS boot sequence. The PEI 318 may include instructions that perform tasks such as memory initialization and recovery operations. After the PEI 318 has executed to initialize the memory 306, the DXE 320 may include instructions that initialize additional hardware drivers, the peripheral component interface bus, run-time services, and the like, of the computing device 100. In an example, the BIOS password 312 may be provided during execution of the DXE 320.

In an example, the controller memory 308 may provide a second memory to store the back-up of the BIOS password 322. The back-up of the BIOS password 322 may provide redundancy in case the memory 306 fails. For example, if the BIOS password 312 becomes corrupted, or inaccessible, the controller 304 may access the back-up BIOS password 322. Thus, the BIOS 302 may complete execution even if the BIOS password 312 is corrupted or unreadable in the memory 306.

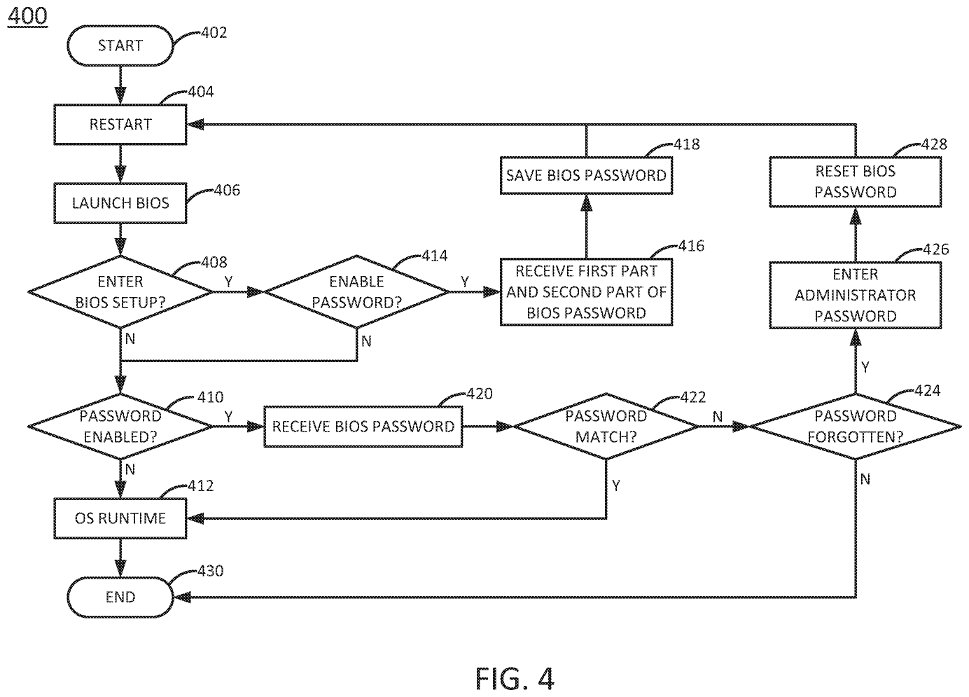

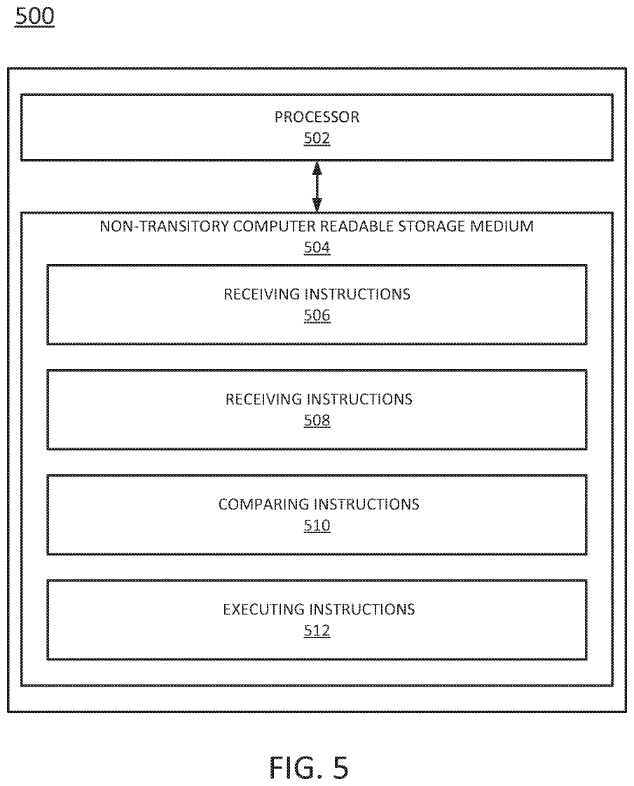

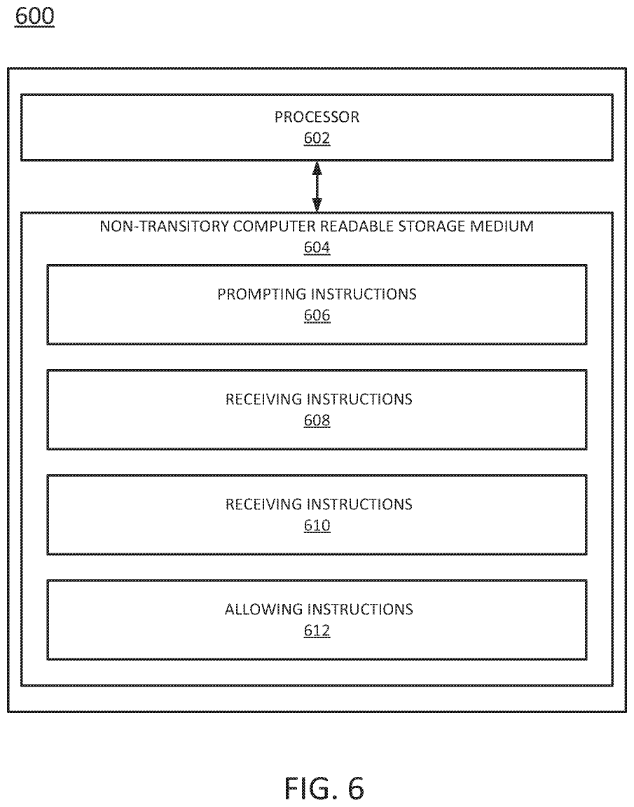

FIG. 4 illustrates a flow diagram of an example method 400 for creating a BIOS password with multiple parts to execute a BIOS of the present disclosure. In an example, the method 400 may be performed by the computing device 100, the apparatus 500 illustrated in FIG. 5, and described below, or the apparatus 600 illustrated in FIG. 6, and described below.

At block 402, the method 400 begins. At block 404, the method 400 restarts the computing device. For example, the computing device may be powered on to start a boot sequence or may be a subsequent re-boot from exiting a BIOS setup or from an operating system (OS) environment.

At block 406, the method 400 launches a BIOS. In an example, the BIOS may be a boot sequence for the computing device that can initialize memory and other devices that are used in the OS environment. The BIOS may be executed before the OS is executed.

In an example, the BIOS may be a UEFI BIOS. The UEFI BIOS may execute a PEI and a DXE as described above.

At block 408, the method 400 determines if the computing device should enter the BIOS setup. In an example, the BIOS setup may allow for customization of various parameters associated with hardware or software applications executed by the computing device. The BIOS setup may provide options related to how the computing device should boot, which hardware devices should be initialized, a sequence of initialization, memory allocation, security parameters, and the like.

The BIOS setup may be entered by pressing a particular key (e.g., a function key on a keyboard) during the BIOS launch. In an example, the BIOS setup may be entered while the DXE is executing.

If the answer to block 408 is yes, the method 400 may proceed to block 414. At block 414, the method 400 may determine if the BIOS password feature should be enabled. For example, one of the options that may be presented in the BIOS setup may be the option to enable the BIOS password with multiple parts. If the answer to block 414 is no, the method 400 may proceed to block 410. If the answer to block 414 is yes, then the method 400 may proceed to block 416.

At block 416, the method 400 may receive a first part and a second part of the BIOS password. As described above, different input devices may be used to provide the different parts of the BIOS password. The first part and the second part may be any combination of alphanumeric text and movements of an input device. The input devices may include a keyboard, a virtual keyboard, a stylus, a touch screen display, a trackpad, a mouse, and the like.

In an example, the alphanumeric text may be a password provided by a keyboard, a sequence of keystrokes on a virtual keyboard on a touch screen display, and the like. The movements may be a pattern of movement, touching a touch screen display at particular locations, touching a trackpad with a particular number of fingers at particular locations on the trackpad, and so forth.

In an example, the movements may be tracked in the BIOS by a console input protocol executed in the BIOS. For example, the input devices may not be fully initialized until after the BIOS is executed. However, the console input protocol may allow the movement of the input devices to be tracked in the BIOS setup.

In an example, the first part and the second part of the BIOS password may also include a sequence of the first part and the second part. For example, the first part may include a password entered by a keyboard and the second part may include a movement of a mouse from left to right. The BIOS password may track a sequence of the first part and the second part. In other words, when the BIOS password is subsequently entered if the second part is provided before the first part, then the BIOS password may be denied even though both inputs are correct.

At block 418, the method 400 saves the BIOS password. In an example, the first part and the second part of the BIOS password may be stored in a main memory of the computing device. The BIOS password may include a list of the devices associated with each part of the BIOS password.

In an example, a back-up copy of the BIOS password may also be saved in a second memory. The second memory may be a secure memory of the BIOS controller. The method 400 may then proceed back to block 404 and restart.

Referring back to block 408, if the answer to block 408 is no, then the method 400 may proceed to block 410. At block 410, the method 400 determines if the BIOS password feature is enabled. If the answer to block 410 is yes, then the method 400 may proceed to block 420.

At block 420, the method 400 receives the BIOS password. For example, a prompt may be provided when the computing device is powered on or after a subsequent re-boot of the computing device. The prompt may allow a user to enter a first part and a second part of the BIOS password. Although the examples herein describe a first part and a second part of the BIOS password, it should be noted that the BIOS password may include three or more parts.

At block 422, the method 400 may determine if the BIOS password that is received matches the stored BIOS password. For example, the received BIOS password may be compared to the saved BIOS password. In an example, each device that provides an input may compared to the list of devices and to the part of the BIOS password that the device provides that is saved in memory. In an example, the sequence in which the parts are provided by respective devices may also be compared to the saved list of devices and to associated parts that comprise the BIOS password that is saved.

If the answer to block 422 is yes, the method 400 may proceed to block 412. If the answer to block 422 is no, the method 400 may proceed to block 424. At block 424, the method 400 determines if the password is forgotten. For example, the user may have forgotten the password, and an indication may be received that the BIOS password is forgotten. For example, the user may select a “forgot password” option in the set-up. If the answer to block 424 is no (e.g., a hacker may be attempting to access the computing device), the method 400 may proceed to block 430, where the method 400 ends.

If the answer to block 424 is yes, the method 400 may proceed to block 426. At block 426, the method 400 enters an administrator password. For example, an administrator of an enterprise that manages the computing device may have an administrator password that can reset the BIOS password.

At block 428, the method 400 resets the BIOS password. For example, the BIOS password may be deleted and the BIOS password feature may be disabled. As a result, the user may restart the computing device and access the BIOS setup to re-enable the BIOS password feature and create a new BIOS password. The method 400 may then return to block 404 to restart the computing device.

Referring back to block 410, if the answer to block 410 is no, the method may proceed to block 412. At block 412, the method 400 may continue to runtime of the operating system. For example, the operating system may be executed either directly from the BIOS execution when no BIOS password is enabled, or in response to a BIOS password match from block 422. At block 430, the method 400 ends.

FIG. 5 illustrates an example of an apparatus 500. In an example, the apparatus 500 may be the computing device 100. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include receiving instructions 506. For example, the instructions 506 may receive a first part of a BIOS password from a first device. For example, the first part may be alphanumeric text or a particular movement of the first device.

The instructions 508 may include receiving instructions. For example, the instructions 510 may receive a second part of the BIOS password from a second device. The second device may be a different device than the first device. The second part may be alphanumeric text or a particular movement of the second device.

The instructions 510 may include comparing instructions. For example, the instructions 510 may compare the first part and the second part to a stored first part and a stored second part of the BIOS password.

The instructions 512 may include executing instructions. For example, the instructions 512 may execute a BIOS in response to the first part and the second part matching a stored first part and a stored second part of the BIOS password.

FIG. 6 illustrates an example of an apparatus 600. In an example, the apparatus 600 may be the computing device 100. In an example, the apparatus 600 may include a processor 602 and a non-transitory computer readable storage medium 604. The non-transitory computer readable storage medium 604 may include instructions 606, 608, 610, and 612 that, when executed by the processor 602, cause the processor 602 to perform various functions.

In an example, the instructions 606 may include prompting instructions 606. For example, the instructions 606 may prompt a user to provide a BIOS password with a first device and a second device during execution of a BIOS of a computing device. The prompt may be provided after a user enters a BIOS setup menu during execution of the BIOS.

The instructions 608 may include receiving instructions. For example, the instructions 608 may receive a first part of the BIOS password via the first device. For example, the first part may be alphanumeric text or a particular movement of the first device.

The instructions 610 may include receiving instructions. For example, the instructions 610 may receive a second part of the BIOS password via a second device. The second device may be a different device than the first device. The second part may be alphanumeric text or a particular movement of the second device.

The instructions 612 may include allowing instructions. For example, the instructions 612 may allow execution of a BIOS to proceed to an operating system environment based on the first part and the second part of the BIOS password that are received. For example, the first part and the second part of the BIOS password that are received may be compared to a first part and a second part of the BIOS password that are stored in memory. If the received first part and second part match the stored first part and second part, then the instructions 612 may authorize execution of the BIOS.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
a basic input/output system (BIOS);
a memory to store a BIOS password, wherein the BIOS password includes a first part and a second part; and
a controller to:
associate a first device with the first part and a second device with the second part.

2. The computing device of claim 1, further comprising:
a driver execution environment (DXE), wherein a prompt to provide the BIOS password via the first device and the second device is provided during execution of the DXE.

3. The computing device of claim 2, wherein a prompt to enter the BIOS password is presented during execution of the DXE on a subsequent re-boot of the computing device.

4. The computing device of claim 1, wherein the memory is to store a console input protocol to track movement of the first device and the second device.

5. The computing device of claim 1, wherein each of the first device and the second device comprises one selected from a group of: a keyboard, a virtual keyboard, a mouse, a trackpad, or a touch screen.

6. The computing device of claim 1, wherein the first part comprises an alphanumeric text and the second part comprises a movement of the second device.

7. The computing device of claim 1, further comprising:
a second memory to store a backup copy of the BIOS password.

8. A non-transitory computer readable storage medium encoded with instructions which, when executed, cause a controller of a computing device to:
receive a first part of a basic input/output system (BIOS) password from a first device;
receive a second part of the BIOS password from a second device;
compare the first part and the second part to a stored first part and a stored second part of the BIOS password; and
execute a BIOS in response to the first part and the second part matching the stored first part and the stored second part of the BIOS password.

9. The non-transitory computer readable storage medium of claim 8, wherein the first part or the second part comprises a pattern of movement of the first device or the second device.

10. The non-transitory computer readable storage medium of claim 9, wherein the pattern of movement comprises touching particular locations on a touch screen.

11. The non-transitory computer readable storage medium of claim 9, wherein the pattern of movement comprises a series of movements along an X-Y plane of an input device.

12. The non-transitory computer readable storage medium of claim 8, wherein the first part or the second part comprises an alphanumeric password entered by a keyboard or a virtual keyboard.

13. A non-transitory computer readable storage medium encoded with instructions which, when executed, cause a processor of a computing device to:
prompt a user to provide a basic input/output system (BIOS) password with a first device and a second device during execution of a BIOS of the computing device;
receive a first part of the BIOS password via the first device;
receive a second part of the BIOS password via the second device; and
allow execution of a BIOS to proceed to an operating system environment based on the first part and the second part of the BIOS password that are received.

14. The non-transitory computer readable storage medium of claim 13, the instructions further causing the processor to:
receive an indication that the BIOS password is forgotten; and
reset the first part and the second part of the BIOS password.

15. The non-transitory computer readable storage medium of claim 14, wherein the instructions to reset comprises instructions to provide an administrator password to reset the first part and the second part of the BIOS password.
